(19) United States
(12) Patent Application Publication
(10) Pub. No.: US 2004/0050980 A1
(43) Pub. Date: Mar. 18, 2004

(54) Fluidic nozzle with stream deflector

(75) Inventors: Zdenek Riha, Zlamanec (CZ); Frantisek Pochyly, Brno (CZ)

Correspondence Address: BURNS, DOANE, SWECKER & MATHIS, L.L.P., P.O. Box 1404, Alexandria, VA, 22313-1404, US

(73) Assignee: HYDROSYSTEM project a.s.

(21) Appl. No.: 10/602,857

(22) Filed: Jun. 25, 2003

(30) Foreign Application Priority Data
Jun. 25, 2002 (CZ) PUV 2002-13250

(51) Int. Cl. B05B 1/00; B05B 1/08; B05B 1/14

(52) U.S. Cl. 239/589.1; 239/589; 239/590

(57) ABSTRACT

Fluidic nozzle for emitting pressurized liquid includes a body forming mutually interconnected chambers including a liquid inlet chamber, an oscillatory chamber, and a liquid outlet chamber together defining a longitudinal axis of the nozzle. The oscillatory chamber includes a vortex section for inducing swirling of the liquid, A stream deflector is disposed in the vortex section upstream of an entrance to the outlet chamber, the stream deflector extending in a direction laterally of the axis from one wall of the vortex section to an opposite wall thereof.

This application claims priority under 35 U.S.C. §§119 and/or 365 to Patent Application Serial No. PUV 2002-13250 filed in the Czech Republic on Jun. 25, 2002, the entire content of which is hereby incorporated by reference.

### BACKGROUND OF THE INVENTION

This technical solution relates to the design of a fluidic nozzle intended especially for cleaning surfaces of bodies using a liquid, which shows very high values of static pressure on the inlet as well as high stream velocity in the oscillatory chamber, this principle being applied e.g., for removing scale from metal sheets upon the rolling process.

At present, the so-called “friction” nozzles are used for cleaning surfaces with liquids, e.g. for the scaling of rolled metal sheets. The value of the inlet static pressure on these nozzles fluctuates around 20 MPa. With these nozzle types, the splattering and cleaning effects produced by the emitted liquid are achieved by suitably shaping the nozzle outlet port.

Well known are also fluidic nozzles, which, in their own way, make the splattering of the streaming medium yet more effective as indicated in the Stouffer et al. U.S. Pat. No. 4,052,002. Upon a suitable design of the nozzle, the liquid jet emitted from the fluidic nozzle can well have the same properties as that discharging from a friction nozzle, while the value of the liquid static pressure on the fluidic nozzle inlet may be considerably lower compared with the friction nozzles. There are various designs of fluidic nozzles, e.g., those covered by the U.S. Pat. No. 4,052,002, U.S. Pat. No. 4,721,251; WO 81/01966; DE-2505695 or CZ-286790, which comprise a body incorporating mutually communicating inlet chamber, oscillatory chamber and outlet chamber. In the oscillatory chamber the liquid jet is set into oscillatory motion prior to leaving through the chamber outlet port.

A common disadvantage of the known designs of fluidic nozzles is the restriction of their function upon high inlet pressures and high velocities of the streaming medium, above all in the oscillatory chamber. The functionality of the said fluidic nozzles ranges around the value of 3 MPa of the inlet static pressure with the nozzle outlet port sized 3.5 mm×4.0 mm. Due to the high velocities, the liquid jet stops pulsing in the oscillatory chamber and is restricted only to flow through it with the liquid vortices becoming stable in this chamber, which is not acceptable from the viewpoint of functionality.

### SUMMARY OF THE INVENTION

The above mentioned disadvantages are to a great extent eliminated by the new fluidic nozzle, especially when used for the cleaning of surfaces using a pressurized liquid, the nozzle comprising a body, which incorporates a mutually interconnected inlet chamber, oscillatory chamber and outlet chamber. The principal feature of the fluidic nozzle is that it has a shaped stream deflector built in the vortex section of the oscillatory chamber upstream of the entrance to the outlet chamber.

The solution principle consists also in the fact that the stream deflector found in the vortex section of the oscillatory chamber is fitted either in the longitudinal axis of the fluidic nozzle or asymmetrically in respect of this longitudinal axis.

Of importance is also the fact that the installation of the stream deflector in the oscillatory chamber can be either removable or permanent, the deflector being preferably of a cylindrical shape.

The new design modification of the fluidic nozzle enables and secures pulsations of the liquid jet in the oscillatory chamber even upon a high static pressure of the liquid on the inlet port exceeding the value of 5 MPa, and upon its high streaming velocities of above 100 in/sec in the oscillatory chamber.

### BRIEF DESCRIPTION OF THE DRAWINGS

The objects and advantages of the invention will become apparent from the following detailed description of a preferred embodiment thereof in connection with the accompanying drawing and in which like numerals designate like elements.

FIG. 1 is a longitudinal sectional view of the fluidic nozzle in a front view.

FIG. 2 is a sectional view taken along line A-A in FIG. 1.

FIG. 3 is a view similar to FIG. 2 of a second embodiment of the invention.

FIG. 4 is a view similar to FIG. 2 of a third embodiment of the invention.

### DESCRIPTION OF PREFERRED EMBODIMENTS OF THE INVENTION

The fluidic nozzle comprises a body 1, which houses mutually interconnected chambers, namely an inlet chamber 2 connected to a source of pressure liquid (not shown), an oscillatory chamber 3 and an outlet chamber 4 provided with an outlet port 41. Fluid travel between the inlet chamber 2 and the oscillatory chamber 3 occurs via a control port 5, while fluid travel between the oscillatory chamber 3 and the outlet chamber 4 is via a port 6. The oscillatory chamber 3 basically comprises a central vortex section 31 and lateral feedback channels 32. In the central vortex section 31 two vortices are produced which render the fluid unstable; the fluid oscillates between the divergent walls of the vortex section 31. At a downstream portion of the vortex section 31, a shaped stream deflector 7 of e.g., cylindrical design is situated in (i.e., intersected by) the longitudinal symmetrical axis of the fluidic nozzle upstream the port 6, which port constitutes an entrance to the outlet chamber 4.

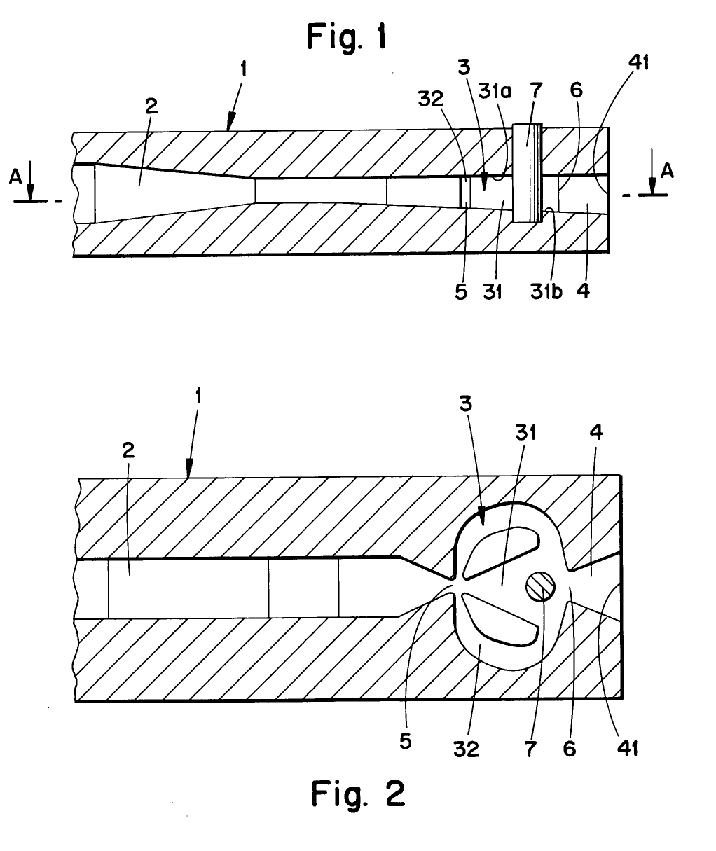

The installation of the stream deflector 7 in the vortex section 31 upstream of the port 6 prevents the liquid jet from flowing out without pulsations being created in the oscillatory chamber 3. The stream deflector makes the flowing liquid fill its whole space even upon high inlet pressures and high streaming velocities. The deflector 7 extends in a direction laterally of the axis A from one wall of the vortex section to an opposite wall thereof, i.e., from top to bottom in FIG. 1, to ensure that fluid will be deflected by the deflector.

The above-described execution of the fluidic nozzle is not the only design possible according to the technical solution. The stream deflector 7 in the oscillatory chamber 3 can namely be permanent or removable and need not be cylindrical in shape but rather its cross-section may obtain a general form as e.g., that of a square, triangle, rectangle or polygon, depending upon the parameters of the flowing medium.

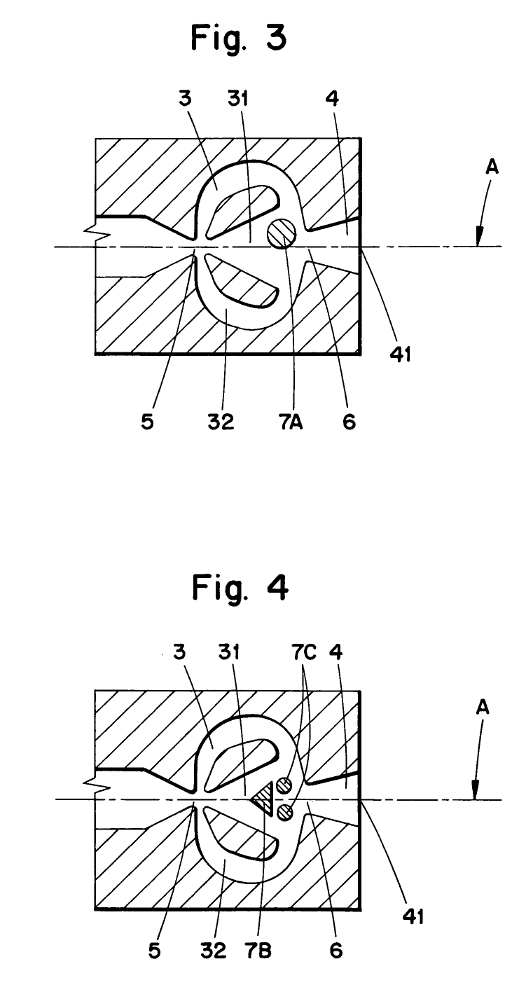

The stream deflector Z may be installed in the vortex section 31 not only in the longitudinal symmetrical axis A-A of the fluidic nozzle but also asymmetrically, depending upon the overall shape of the oscillatory chamber 3, the execution of the lateral feedback channels 32 and/or the shape of the port 6 or of the outlet chamber 4. Such asymmetrical arrangements are depicted in FIGS. 3 and 4. Shown in FIG. 3 is a deflector 7A similar to the deflector 7 of FIG. 2, but arranged asymmetrically with respect to the axis A.

Depicted in FIG. 4 is a deflector which comprises an upstream deflector part 7B, and two downstream deflector parts 7C. The upstream part 7B has a triangular cross section, and is symmetrical with the axis A. Each of the downstream parts 7C has a circular cross section, and those parts 7C are arranged on opposite sides of the axis A, i.e., symmetrically with respect to the axis. In the end, the body 1 may assume various shapes in accordance with the invention.

The fluidic nozzle according to the technical solution can be utilized for the cleaning of surfaces using high-pressure liquid as e.g. for removing scale from surfaces of rolled metal sheets, or for spreading liquids onto surfaces of bodies under the condition of high inlet static pressure of the liquid on the inlet port and of high streaming velocities of the liquid jet in the oscillatory chamber.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. Fluidic nozzle for emitting pressurized liquid comprising a body forming mutually interconnected chambers including a liquid inlet chamber, an oscillatory chamber, and a liquid outlet chamber together defining a longitudinal axis of the nozzle; the oscillatory chamber including a vortex section for inducing swirling of the liquid; and a stream deflector disposed in the vortex section upstream of an entrance to the outlet chamber, the stream deflector extending in a direction laterally of the axis from one wall of the vortex section to an opposite wall thereof.

2. The fluidic nozzle according to claim 1 wherein the deflector is arranged symmetrically with respect to the axis.

3. The fluidic nozzle according to claim 1 wherein the deflector is arranged asymmetrically with respect to the axis.

4. The fluidic nozzle according to claim 1 wherein the deflector comprises a plurality of deflector parts arranged symmetrically and asymmetrically respectively, with respect to the axis.

5. The fluidic nozzle according to claim 4 wherein the symmetrical deflector part is located upstream of the asymmetrical deflector part.

6. The fluidic nozzle according to claim 1 wherein the deflector is removably mounted in the body.

7. The fluidic nozzle according to claim 1 wherein the deflector is permanently mounted in the body.

8. The fluidic nozzle according to claim 1 wherein the deflector has a cylindrical shape.

9. Fluidic nozzle intended for emitting a pressurized liquid stream, comprising a body forming mutually interconnected chambers defining a longitudinal axis of the nozzle, the chambers including an inlet chamber for receiving pressurized liquid, an oscillatory chamber, and an outlet chamber for discharging the pressurized stream; the oscillatory chamber including a vortex chamber for inducing swirling of the liquid; a lateral feedback channel extending around the vortex chamber; a stream deflector disposed in the vortex chamber and spaced upstream from an entrance to the outlet chamber, wherein the mutually interconnected chambers define a longitudinal axis of the nozzle, and the deflector is arranged asymmetrically with respect to the axis and extends in a direction laterally of the axis from a wall of the vortex section to an opposite wall thereof.

10. The fluidic nozzle according to claim 9 wherein the deflector comprises a plurality of deflector parts arranged symmetrically and asymmetrically respectively, with respect to the axis.

11. The fluidic nozzle according to claim 10 wherein the symmetrical deflector part is located upstream of the asymmetrical deflector part.
